(19) United States
(12) Patent Application Publication
(10) Pub. No.: US 2021/0212137 A1
(43) Pub. Date: Jul. 8, 2021

(54) NETWORK NODE, SERVER AND METHODS FOR FACILITATING NON-IP DATA DELIVERY

(71) Applicant: Telefonaktiebolaget LM Ericsson (publ), Stockholm (SE)

(72) Inventors: Jingrui TAO, GUANGZHOU (CN); Fengpei ZHANG, GUANGZHOU (CN); Yun ZHANG, BEIJING (CN); Wenliang XU, SHANGHAI (CN)

(21) Appl. No.: 17/269,075

(22) PCT Filed: Mar. 27, 2020
(86) PCT No.: PCT/CN2020/081718

§ 371 Date: Feb. 17, 2021

(30) Foreign Application Priority Data
Mar. 29, 2019 (CN) PCT/CN2019/080567

(51) Int. Cl. H04W 76/12; H04W 72/04; H04W 76/18; H04W 8/18

(52) U.S. Cl. CPC H04W 76/12; H04W 8/18; H04W 76/18; H04W 72/0413

(57) ABSTRACT

The present disclosure provides a method in a network node for facilitating Non-Internet Protocol Data Delivery, NIDD. The method includes: receiving from a server a request for NIDD downlink data transfer to a terminal device; triggering, when no Packet Data Network, PDN, connection is available between the terminal device and the network node, establishment by the terminal device of a PDN connection with the network node; and notifying the server when the PDN connection has been established.

### TECHNICAL FIELD

The present disclosure relates to communication technology, and more particularly, to a network node, a server and methods therein for facilitating Non-Internet Protocol Data Delivery (NIDD).

### BACKGROUND

NIDD over Service Capability Exposure Function (SCEF) has been defined in the 3^{rd} Generation Partnership Project (3GPP) Technical Specification (TS) 23.682, V15.5.0, 2018 June, which is incorporated herein by reference in its entirety. In particular, NIDD over SCEF supports Mobile Originated (MO) communication, for Non-IP Data from a User Equipment (UE) to a Service Capability Server/Application Server (SCS/AS), and Mobile Terminated (MT) communication, for Non-IP Data from an SCS/AS to a UE.

NIDD over SCEF is based on a non-IP Packet Data Network (PDN) connection between a UE and an SCEF node. The UE may establish such non-IP PDN connection with the SCEF node during an attach procedure or via UE requested PDN connectivity or via a Packet Data Protocol (PDP) Context Activation Procedure.

Before an SCS/AS can transmit non-IP data to the UE, an association between the SCS/AS and the PDN Connection needs to be established in an NIDD Configuration procedure. In the NIDD Configuration procedure, the SCS/AS transmits an NIDD Configuration Request to the SCEF node, requesting for creating an NIDD configuration for the UE in the SCEF node. The NIDD configuration is associated with, e.g., an Access Point Name (APN) and an identity (e.g., International Mobile Station Identity (IMSI) or Mobile Station Integrated Services Digital Network Number (MSISDN)) of the UE. The SCEF node shall check whether the SCS/AS is authenticated and authorized to create such NIDD configuration, and if so, authorize the NIDD configuration.

Upon receiving from the SCS/AS a request for NIDD downlink data transfer to the UE, the SCEF node shall verify the presence of the NIDD configuration and check whether the SCS/AS is authorized to send such request. If the NIDD configuration is present and the SCS/AS is authorized to send the request, the SCEF node determines whether a non-IP PDN connection associated with the APN and the identity of the UE is available between the SCEF node and the UE. If such PDN connection is not found, e.g., when it has not been established or when it has been removed as the UE has been in a sleep mode for a long time, the SCEF node may, depending on a PDN Connection Establishment Option contained in the NIDD Configuration Request:
for PDN Connection Establishment Option 1 (referred to as Option 1 hereinafter): reject the request for NIDD downlink data transfer and send an error message to the SCS/AS;
for PDN Connection Establishment Option 2 (referred to as Option 2 hereinafter): send a Device Trigger to the UE, e.g., via Short Message Service (SMS), for requesting the UE to establish a PDN connection with the SCEF node, without buffering non-IP data from the SCS/AS, and respond to the SCS/AS with a 200 OK response containing a status code of “Failed”; or
for PDN Connection Establishment Option 3 (referred to as Option 3 hereinafter): buffer non-IP data from the SCS/AS, send a Device Trigger to the UE via SMS for requesting the UE to establish a PDN connection with the SCEF node, and then send a 201 Created response to the SCS/AS, the response containing a status code of “Triggered”, indicating that the Device Trigger has been sent and the data has been buffered by the SCEF node.

In the above Options 2 and 3, once the UE receives the Device Trigger from the SCEF node, it will establish a non-IP PDN connection with the SCEF node in a UE requested PDN connectivity procedure or PDP Context Activation procedure. In the above Option 3, the SCEF node will send the buffered non-IP data to the UE once the non-IP PDN connection is established.

### SUMMARY

It is an object of the present disclosure to provide a network node, a server and methods therein for facilitating NIDD.

According to a first aspect of the present disclosure, a method in a network node for facilitating NIDD is provided. The method includes: receiving from a server a request for NIDD downlink data transfer to a terminal device; triggering, when no PDN connection is available between the terminal device and the network node, establishment by the terminal device of a PDN connection with the network node; and notifying the server when the PDN connection has been established.

In an embodiment, the method may further include: receiving from the server an NIDD configuration request containing a PDN connection establishment option requesting the network node to trigger establishment by the terminal device of a PDN connection with the network node when no PDN connection is available between the terminal device and the network node.

In an embodiment, the PDN connection establishment option may further request the network node to buffer data from the server when no PDN connection is available between the terminal device and the network node. The method may further include: buffering data contained in the request for NIDD downlink data transfer when no PDN connection is available between the terminal device and the network node; and transmitting, subsequent to triggering establishment of the PDN connection, to the server a response indicating that the establishment of the PDN connection has been triggered and the data has been buffered.

In an embodiment, the PDN connection establishment option may not request the network node to buffer data from the server when no PDN connection is available between the terminal device and the network node. The method may further include: transmitting to the server a response indicating delivery failure when no PDN connection is available between the terminal device and the network node.

In an embodiment, the NIDD configuration request may further contain an indication requesting the network node to notify the server when the PDN connection has been established.

In an embodiment, the request for NIDD downlink data transfer may further contain an indication requesting the network node to notify the server when the PDN connection has been established.

In an embodiment, the method may further include: negotiating with the server one or more supported features for an NIDD Application Programming Interface (API) between the network node and the server, the one or more supported features including a feature to notify the server when the PDN connection has been established.

In an embodiment, the network node may be an SCEF node or a Network Exposure Function (NEF) node, the server may be an SCS/AS, the request for NIDD downlink data transfer may be an MT NIDD Submit Request, the operation of triggering establishment of the PDN connection may include transmitting a Device Trigger destined to the terminal device, and/or the operation of notifying the server when the PDN connection has been established may include transmitting to the server an NIDD Configuration Update Notification containing an indication that the PDN connection has been established.

According to a second aspect of the present disclosure, a network node is provided. The network node includes a communication interface, a processor and a memory. The memory contains instructions executable by the processor whereby the network node is operative to perform the method according to the above first aspect.

According to a third aspect of the present disclosure, a computer readable storage medium is provided. The computer readable storage medium has computer program instructions stored thereon. The computer program instructions, when executed by a processor in a network node, cause the network node to perform the method according to the above first aspect.

According to a fourth aspect of the present disclosure, a method in a server for facilitating NIDD is provided. The method includes: transmitting to a network node a request for NIDD downlink data transfer to a terminal device; receiving from the network node a response without an indication of delivery success; and receiving from the network node a notification that a PDN connection has been established between the terminal device and the network node.

In an embodiment, the method may further include: transmitting to the network node an NIDD configuration request containing a PDN connection establishment option requesting the network node to trigger establishment by the terminal device of a PDN connection with the network node when no PDN connection is available between the terminal device and the network node.

In an embodiment, the PDN connection establishment option may further request the network node to buffer data from the server when no PDN connection is available between the terminal device and the network node, and the response may indicate that the establishment of the PDN connection has been triggered and the data has been buffered.

In an embodiment, the PDN connection establishment option may not request the network node to buffer data from the server when no PDN connection is available between the terminal device and the network node, and the response may indicate delivery failure.

In an embodiment, the NIDD configuration request may further contain an indication requesting the network node to notify the server when the PDN connection has been established.

In an embodiment, the request for NIDD downlink data transfer may contain an indication requesting the network node to notify the server when the PDN connection has been established.

In an embodiment, the method may further include: negotiating with the network node one or more supported features for an NIDD API between the network node and the server, the one or more supported features including a feature to notify the server when the PDN connection has been established.

In an embodiment, the method may further include: transmitting to the network node a further request for NIDD downlink data transfer to the terminal device in response to the notification.

In an embodiment, the server may be an SCS/AS, the network node may be an SCEF node or an NEF node, the request for NIDD downlink data transfer may be an MT NIDD Submit Request, and/or the notification may be an NIDD Configuration Update Notification.

According to a fifth aspect of the present disclosure, a server is provided. The server includes a communication interface, a processor and a memory. The memory contains instructions executable by the processor whereby the server is operative to perform the method according to the above fourth aspect.

According to a sixth aspect of the present disclosure, a computer readable storage medium is provided. The computer readable storage medium has computer program instructions stored thereon. The computer program instructions, when executed by a processor in a server, cause the server to perform the method according to the above fourth aspect.

With the embodiments of the present disclosure, when a network node receives from a server a request for NIDD downlink data transfer to a terminal device while no PDN connection is available between the terminal device and the network node, it can trigger establishment by the terminal device of a PDN connection with the network node and notify the server when the PDN connection has been established. Accordingly, the server can learn that the terminal device is now reachable and then request NIDD downlink data transfer to the terminal device again. In this way, the server does not need to retry NIDD downlink data transfer to the terminal device blindly, which makes the NIDD procedure more efficient.

### BRIEF DESCRIPTION OF THE DRAWINGS

The above and other objects, features and advantages will be more apparent from the following description of embodiments with reference to the figures, in which:

FIG. 1 is a flowchart illustrating a method in a network node for facilitating NIDD according to an embodiment of the present disclosure;

FIG. 2 is a flowchart illustrating a method in a server for facilitating NIDD according to an embodiment of the present disclosure;

FIG. 3 is a schematic diagram showing an NIDD configuration procedure according to an embodiment of the present disclosure;

FIG. 4 is a sequence diagram showing an MT NIDD procedure according to an embodiment of the present disclosure;

FIG. 5 is a block diagram of a network node according to an embodiment of the present disclosure;

FIG. 6 is a block diagram of a network node according to another embodiment of the present disclosure;

FIG. 7 is a block diagram of a server according to an embodiment of the present disclosure; and

FIG. 8 is a block diagram of a server according to another embodiment of the present disclosure.

### DETAILED DESCRIPTION

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms. The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

In Option 2 as described above, while the UE will establish a non-IP PDN connection with the SCEF node in response to receiving a Device Trigger from the SCEF node, the SCS/AS does not know when the PDN connection will be established and can only retry NIDD downlink data transfer to the UE blindly, which would be inefficient as it may result in a number of unnecessary NIDD failures. In Option 3, while the SCEF node can transmit the buffered data to the UE when the PDN connection has been established, it would also be beneficial if the SCS/AS can be explicitly notified when PDN connection has been established.

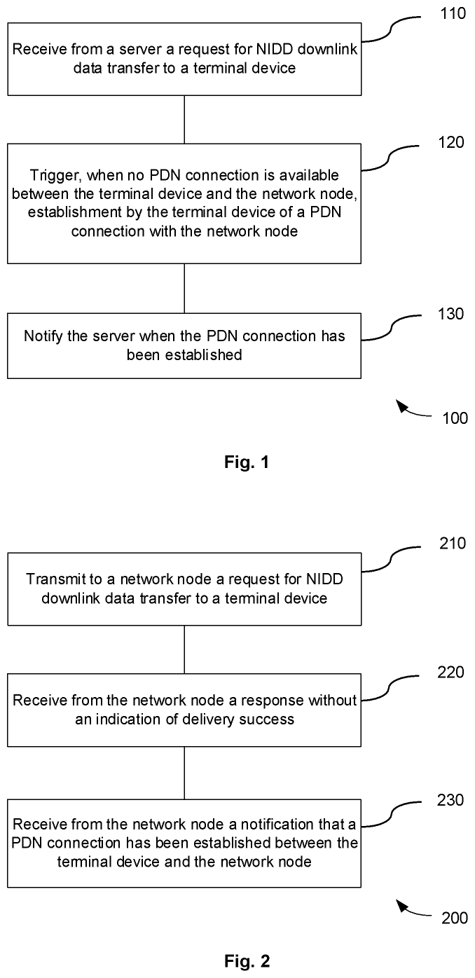

FIG. 1 is a flowchart illustrating a method 100 for facilitating NIDD according to an embodiment of the present disclosure. The method 100 can be performed at a network node, e.g., an SCEF node in the 4^{th} Generation (4G) communication protocol, a Network Exposure Function (NEF) node in the 5^{th} Generation (5G) communication protocol or any network node having equivalent or similar functions in future communication protocols.

At block 110, a request for NIDD downlink data transfer to a terminal device is received from a server. Here, the server can be an SCS/AS and the terminal device can be a UE, e.g., a Cellular Internet of Things (CIoT) device. The request for NIDD downlink data transfer can be an MT NIDD Submit Request in an MT NIDD procedure.

At block 120, when no PDN connection is available between the terminal device and the network node, establishment by the terminal device of a PDN connection with the network node is triggered. In an example, the establishment is triggered by transmitting a Device Trigger destined to the terminal device, e.g., via SMS.

In an example, in an NIDD Configuration procedure prior to the MT NIDD procedure, the network node can receive from the server an NIDD configuration request containing a PDN connection establishment option (e.g., Option 2 or Option 3 as described above) requesting the network node to trigger establishment by the terminal device of a PDN connection with the network node when no PDN connection is available between the terminal device and the network node. In an example, the PDN connection establishment option (e.g., Option 3 in this case) may further request the network node to buffer data from the server when no PDN connection is available between the terminal device and the network node. In this case the network node can buffer data contained in the request for NIDD downlink data transfer when no PDN connection is available between the terminal device and the network node, and transmit to the server a response indicating that the establishment of the PDN connection has been triggered and the data has been buffered after triggering establishment of the PDN connection. Alternatively, the PDN connection establishment option (e.g., Option 2 in this case) may not request the network node to buffer data from the server when no PDN connection is available between the terminal device and the network node. In this case, the network node can transmit to the server a response indicating delivery failure when no PDN connection is available between the terminal device and the network node.

At block 130, the server is notified when the PDN connection has been established. In an example, in the block 130, an NIDD Configuration Update Notification containing an indication that the PDN connection has been established can be transmitted to the server. For example, the data type NiddConfigurationStatusNotification in the NIDD Configuration Update Notification as defined in Table 5.6.2.1.6-1 of 3GPP TS 29.122, V15.0.0, 2018 June, which is incorporated herein by reference in its entirety, can be extended to support such indication, as shown in Table 1 below.

TABLE 1
Definition of type NiddConfigurationStatusNotification

| Attribute name | Data type | Cardinality | Description | Applicability |
|---|---|---|---|---|
| niddConfiguration | Link | 1 | Link to the NIDD configuration resource to | |
| | | | which this notification is related. | |
| externalId | ExternalId | 0..1 | Each element uniquely identifies a user as | |
| | | | defined in Clause 4.6.2 of 3GPP TS 23.682. | |
| Msisdn | Msisdn | 0..1 | Each element identifies the MS internal | |
| | | | PSTN/ISDN number allocated for a UE. | |
| status | NiddStatus | 1 | Indicates the NIDD configuration status. | |
| deviceTriggerStatus | DeviceTrigger | 0..1 | Indicates the device trigger status | |
| | Status | | | |

In Table 1, an attribute “deviceTriggerStatus” can be introduced to indicate a Device Trigger status, i.e., whether the PDN connection has been established in response to the Device Trigger. For example, the value of the attribute “deviceTriggerStatus” can be defined in Table 2 below.

TABLE 2
Definition of type DeviceTriggerStatus

| Enumeration value | Description |
|---|---|
| PDN_CONNCTION_ESTABLISHED | The SCEF includes this value |
| | in the response for a successful |
| | device triggering action of |
| | establishing Non-IP or IP |
| | connection. |

The notification in the block 130 can be provided by the network node by default or at request of the server. In the latter case, such request can be included in the NIDD configuration request or in the request for NIDD downlink data transfer. For example, the NIDD configuration request may further contain an indication requesting the network node to notify the server when the PDN connection has been established. For example, the data type NiddConfiguration as defined in Table 5.6.2.1.2-1 of 3GPP TS 29.122 can be extended to support such indication, as shown in Table 3 below.

TABLE 3
Definition of type NiddConfiguration

| Attribute name | Data type | Cardinality | Description | Applicability |
|---|---|---|---|---|
| Self | Link | 0..1 | Link to this resource. This | |
| | | | parameter shall be supplied by | |
| | | | the SCEF in HTTP responses. | |
| supportedFeatures | SupportedFeatures | 0..1 | Used to negotiate the supported | |
| | | | optional features of the API as | |
| | | | described in subclause 5.2.7. | |
| | | | This attribute shall be provided in | |
| | | | the POST request and in the | |
| | | | response of successful resource | |
| | | | creation. | |
| externalId | ExternalId | 0..1 | Each element uniquely identifies | |
| | | | a user as defined in subclause 4.6.2 | |
| | | | of 3GPP TS 23.682. | |
| Msisdn | Msisdn | 0..1 | Each element identifies the MS | |
| | | | internal PSTN/ISDN number | |
| | | | allocated for a UE. | |
| externalGroupId | ExternalGroupId | 0..1 | Identifies a user group as defined | GroupMessage |
| | | | in subclause 4.6.3 of | Delivery |
| | | | 3GPP TS 23.682. | |
| DeviceTriggerNotification | Boolean | 0..1 | Indicates if SCEF should send | |
| | | | Device Trigger Notification to | |
| | | | SCS/AS when | |
| | | | PdnEstablishmentOptions is | |
| | | | “SEND_TRIGGER”, and UE | |
| | | | establishes the Non-IP PDN | |
| | | | connection to SCEF after | |
| | | | receiving the device trigger from | |
| | | | SCEF. | |
| . . . | . . . | . . . | . . . | |

In Table 3, an attribute “DeviceTriggerNotification” can be introduced to indicate that the network node shall notify the server when the PDN connection has been established in response to the Device Trigger (e.g., when the value of “DeviceTriggerNotification” is 1).

Alternatively, the request for NIDD downlink data transfer may contain an indication requesting the network node to notify the server when the PDN connection has been established. For example, the data type NiddDownlinkDataTransfer as defined in Table 5.6.2.1.3-1 of 3GPP TS 29.122 can be extended to support such indication, as shown in Table 4 below.

TABLE 4
Definition of type NiddDownlinkDataTransfer

| Attribute name | Data type | Cardinality | Description | Applicability |
|---|---|---|---|---|
| externalId | ExternalId | 0..1 | Each element uniquely | |
| | | | identifies a user as defined | |
| | | | in subclause 4.6.2 of | |
| | | | 3GPP TS 23.682. | |
| externalGroupId | ExternalGroupId | 0..1 | Identifies a user group as | GroupMessageDelivery |
| | | | defined in subclause 4.6.3 of | |
| | | | 3GPP TS 23.682. | |
| msisdn | Msisdn | 0..1 | Each element identifies the | |
| | | | MS internal PSTN/ISDN | |
| | | | number allocated for a UE. | |
| self | Link | 0..1 | Link to the resource | |
| | | | “Individual NIDD downlink | |
| | | | data delivery”. This | |
| | | | parameter shall be supplied | |
| | | | by the SCEF in HTTP | |
| | | | responses. | |
| data | Bytes | 1 | The non-IP data that needed | |
| | | | to be delivered to UE from | |
| | | | the SCS/AS. | |
| DeviceTriggerNotification | Boolean | 0..1 | Indicates if SCEF should | |
| | | | send Device Trigger | |
| | | | Notification to SCS/AS | |
| | | | when | |
| | | | PdnEstablishmentOptions is | |
| | | | “SEND_TRIGGER”, and | |
| | | | UE establishes the Non-IP | |
| | | | PDN connection to SCEF | |
| | | | after receiving the device | |
| | | | trigger from SCEF. | |

In Table 4, an attribute “DeviceTriggerNotification” can be introduced to indicate that the network node shall notify the server when the PDN connection has been established in response to the Device Trigger (e.g., when the value of “DeviceTriggerNotification” is 1).

In an example, the network node can negotiate with the server one or more supported features for an NIDD API between the network node and the server. The one or more supported features may include a feature to notify the server when the PDN connection has been established. The network node may provide the notification only when the feature is supported by the NIDD API. For example, the features used by NIDD API as defined in Table 5.6.4-1 of 3GPP TS 29.122 can be extended to support such negotiation, as shown in Table 5 below.

TABLE 5
Features used by NIDD API

| Feature | | |
|---|---|---|
| Number | Feature | Description |
| 1 | GroupMessageDelivery | This feature indicates the support of group message delivery via |
| | | MT NIDD as defined in subclause 5.5.3 of 3GPP TS 23.682. |
| 2 | Notification_websocket | The delivery of notifications over Websocket is supported |
| | | according to subclause 5.2.5.4. This feature requires that the |
| | | Notification_test_event featute is also supported. |
| 3 | Notification_test_event | The testing of notification connection is supported according to |
| | | subclause 5.2.5.3. |
| 4 | MT_NIDD_modification_cancellation | Modification and cancellation of an individual MT NIDD |
| | | resource. |
| 5 | Notification_Device_Trigger_Status | The delivery of device trigger status notification is supported. |

In Table 5, a feature “Notification_Device_Trigger_Status” is added to indicate support of notification of the Device Trigger status.

FIG. 2 is a flowchart illustrating a method 200 for facilitating NIDD according to an embodiment of the present disclosure. The method 200 can be performed at a server, e.g., an SCS/AS.

At block 210, a request for NIDD downlink data transfer to a terminal device is transmitted to a network node. Here, the terminal device can be a UE, e.g., a CIoT device, and the network node can be e.g., an SCEF node, an NEF node or any network node having equivalent or similar functions in future communication protocols. The request for NIDD downlink data transfer can be an MT NIDD Submit Request in an MT NIDD procedure.

At block 220, a response without an indication of delivery success is received from the network node, e.g., when no PDN connection is available between the terminal device and the network node.

In an example, in an NIDD Configuration procedure prior to the MT NIDD procedure, the server can transmit to the network node an NIDD configuration request containing a PDN connection establishment option (e.g., Option 2 or Option 3 as described above) requesting the network node to trigger establishment by the terminal device of a PDN connection with the network node when no PDN connection is available between the terminal device and the network node. In an example, the PDN connection establishment option (e.g., Option 3 in this case) may further request the network node to buffer data from the server when no PDN connection is available between the terminal device and the network node. In this case the response can indicate that the establishment of the PDN connection has been triggered and the data has been buffered. Alternatively, the PDN connection establishment option (e.g., Option 2 in this case) may not request the network node to buffer data from the server when no PDN connection is available between the terminal device and the network node. In this case, the response can indicate delivery failure.

At block 230, a notification that a PDN connection has been established between the terminal device and the network node is received from the network node. In an example, the notification in the block 230 can be an NIDD Configuration Update Notification. For example, the data type NiddConfigurationStatusNotification in the NIDD Configuration Update Notification as defined in Table 5.6.2.1.6-1 of 3GPP TS 29.122 can be extended to support such indication, as shown in the above Table 1.

The notification in the block 230 can be provided by the network node by default or at request of the server. In the latter case, such request can be included in the NIDD configuration request or in the request for NIDD downlink data transfer. For example, the NIDD configuration request may further contain an indication requesting the network node to notify the server when the PDN connection has been established. For example, the data type NiddConfiguration as defined in Table 5.6.2.1.2-1 of 3GPP TS 29.122 can be extended to support such indication, as shown in the above Table 3. Alternatively, the request for NIDD downlink data transfer may contain an indication requesting the network node to notify the server when the PDN connection has been established. For example, the data type NiddDownlinkDataTransfer as defined in Table 5.6.2.1.3-1 of 3GPP TS 29.122 can be extended to support such indication, as shown in the above Table 4.

In an example, the server can negotiate with the network node one or more supported features for an NIDD API between the network node and the server. The one or more supported features can include a feature to notify the server when the PDN connection has been established. The server may request the network node to provide the notification only when the feature is supported by the NIDD API. For example, the features used by NIDD API as defined in Table 5.6.4-1 of 3GPP TS 29.122 can be extended to support such negotiation, as shown in the above Table 5.

In an example, the network node can transmit to the network node a further request for NIDD downlink data transfer to the terminal device in response to the notification received in the block 230, e.g., to retransmit the data (in the case of Option 2 for example) or transmit further data (in the case of Option 3 for example) to the terminal device.

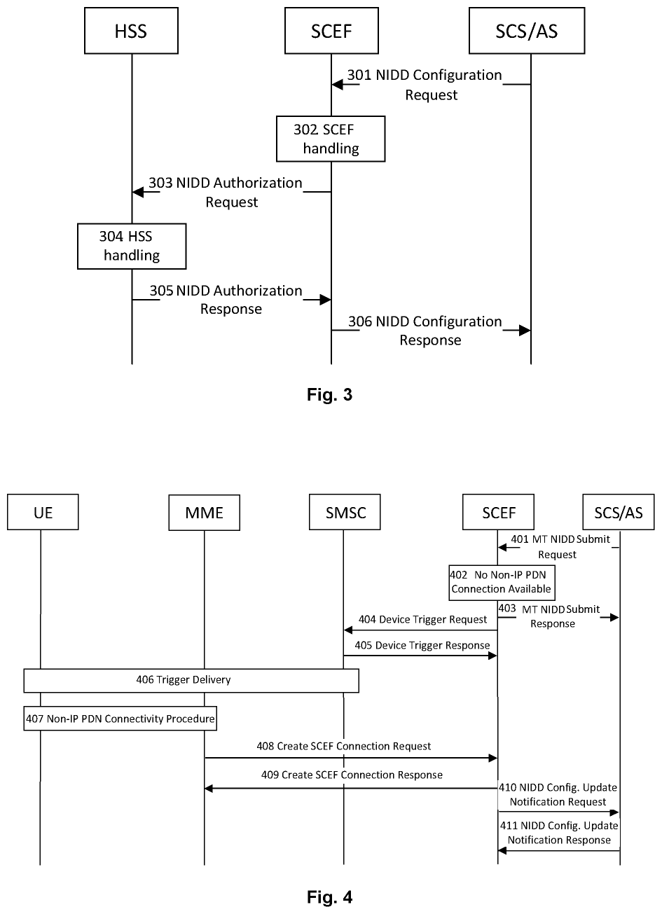

FIG. 3 is a schematic diagram showing an NIDD configuration procedure according to an embodiment of the present disclosure. As shown, at 301, an SCS/AS sends an NIDD Configuration Request for a UE to an SCEF (or NEF) node. The NIDD Configuration Request may contain a PDN Connection Establishment Option (e.g., Option 2 or Option 3). Optionally, the NIDD Configuration Request may further contain e.g., an attribute “DeviceTriggerNotification” in Table 3 to indicate that the SCEF node shall notify the SCS/AS when a PDN connection has been established between the UE and the SCEF node in response to a Device Trigger. At 302, the SCEF node processes the NIDD Configuration Request, e.g., determining whether the SCS/AS is authorized to send the request. At 303, the SCEF node sends an NIDD Authorization Request message to a Home Subscriber Server (HSS) or Unified Data Management (UDM) node for authorization of the NIDD configuration request. At 304, the HSS examines the NIDD Authorization Request message. At 305, the HSS sends an NIDD Authorization Response message to the SCEF node to acknowledge acceptance of the NIDD Authorization Request. At 306, the SCEF node sends an NIDD Configuration Response to the SCS/AS to acknowledge acceptance of the NIDD Configuration Request. For further details of the NIDD configuration procedure, reference can be made to 3GPP TS 23.682 and description thereof will be omitted here.

FIG. 4 is a sequence diagram showing an MT NIDD procedure according to an embodiment of the present disclosure. As shown, at 401, an SCS/AS sends an MT NIDD Submit Request to an SCEF (or NEF) node, requesting for downlink data transfer to a UE. The MT NIDD Submit Request may optionally contain e.g., an attribute “DeviceTriggerNotification” in Table 4 to indicate that the network node shall notify the SCS/AS when a PDN connection has been established in response to a Device Trigger. At 402, the SCEF node determines that there is no non-IP PDN connection available between the UE and the SCEF node. In this case, if an NIDD Configuration Request received from the SCS/AS in a previous NIDD configuration procedure indicates Option 2 or Option 3, the SCEF node sends a Device Trigger Request to a Short Message Service Center (SMSC) at 404 (and buffers data from the SCS/AS in the case of Option 3), and then receives a Device Trigger Response from the SMSC at 405. At 406, the SMSC delivers a Device Trigger to the UE. Upon receiving the trigger, at 407, the UE initiates a Non-IP PDN Connectivity procedure towards a Mobility Management Entity (MME) or an Access and Mobility Management Function (AMF) node, requesting for establishing a non-IP PDN connection with the SCEF node. The MME then sends a Create SCEF Connection Request to the SCEF node at 408. At 409, the SCEF node sends a Create SCEF Connection Response back to the MME. The non-IP PDN connection between the UE and the SCEF node is not established. Accordingly, in the case of Option 3, the SCEF node can send the buffered data to the UE. At 410, the SCEF node sends an NIDD Configuration Update Notification Request to the SCS/AS. The NIDD Configuration Update Notification Request may contain e.g., an attribute “deviceTriggerStatus” in Table 1 to indicate that the non-IP PDN connection has been established in response to the Device Trigger. At 411, the SCS/AS sends an NIDD Configuration Update Notification Response back to the SCEF node. In this case, the SCS/AS can send a further MT NIDD Submit Request to the SCEF node for downlink data transfer to the UE. For further details of the MT NIDD procedure, reference can be made to 3GPP TS 23.682 and description thereof will be omitted here.

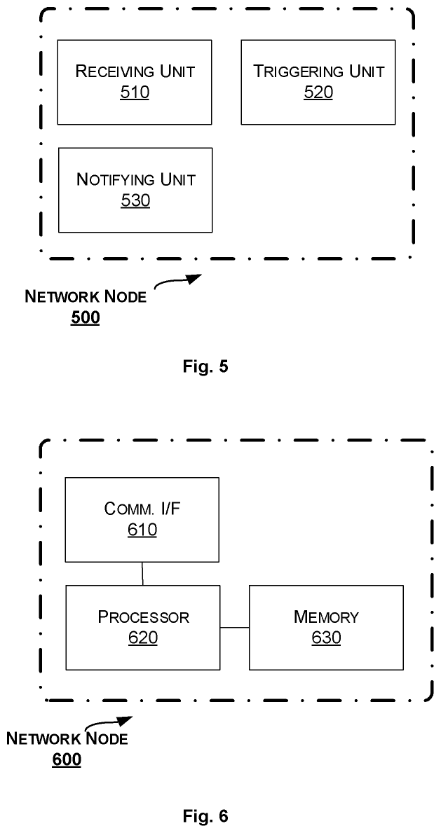

Correspondingly to the method 100 as described above, a network node is provided. FIG. 5 is a block diagram of a network node 500 according to an embodiment of the present disclosure.

As shown in FIG. 5, the network node 500 includes a receiving unit 510 configured to receive from a server a request for NIDD downlink data transfer to a terminal device. The network node 500 further includes a triggering unit 520 configured to trigger, when no PDN connection is available between the terminal device and the network node, establishment by the terminal device of a PDN connection with the network node. The network node 500 further includes a notifying unit 530 configured to notify the server when the PDN connection has been established.

In an embodiment, the receiving unit 510 can be further configured to receive from the server an NIDD configuration request containing a PDN connection establishment option requesting the network node to trigger establishment by the terminal device of a PDN connection with the network node when no PDN connection is available between the terminal device and the network node.

In an embodiment, the PDN connection establishment option may further request the network node to buffer data from the server when no PDN connection is available between the terminal device and the network node. The network node 500 may further include a buffering unit configured to buffer data contained in the request for NIDD downlink data transfer when no PDN connection is available between the terminal device and the network node. The network node 500 may further include a transmitting unit configured to transmit, subsequent to triggering establishment of the PDN connection, to the server a response indicating that the establishment of the PDN connection has been triggered and the data has been buffered.

In an embodiment, the PDN connection establishment option may not request the network node to buffer data from the server when no PDN connection is available between the terminal device and the network node. The network node 500 may further include a transmitting unit configured to transmit to the server a response indicating delivery failure when no PDN connection is available between the terminal device and the network node.

In an embodiment, the NIDD configuration request may further contain an indication requesting the network node to notify the server when the PDN connection has been established.

In an embodiment, the request for NIDD downlink data transfer may further contain an indication requesting the network node to notify the server when the PDN connection has been established.

In an embodiment, the network node 500 may further include a negotiating unit configured to negotiate with the server one or more supported features for an NIDD API between the network node and the server, the one or more supported features including a feature to notify the server when the PDN connection has been established.

In an embodiment, the network node may be an SCEF node or an NEF node, the server may be an SCS/AS, the request for NIDD downlink data transfer may be an MT NIDD Submit Request, the operation of triggering establishment of the PDN connection may include transmitting a Device Trigger destined to the terminal device, and/or the operation of notifying the server when the PDN connection has been established may include transmitting to the server an NIDD Configuration Update Notification containing an indication that the PDN connection has been established.

The receiving unit 510, the triggering unit 520 and the notifying unit 530 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 1.

FIG. 6 is a block diagram of a network node 600 according to another embodiment of the present disclosure.

The network node 600 includes a communication interface 610, a processor 620 and a memory 630. The memory 630 contains instructions executable by the processor 620 whereby the network node 600 is operative to perform the actions, e.g., of the procedure described earlier in conjunction with FIG. 1. Particularly, the memory 630 contains instructions executable by the processor 620 whereby the network node 600 is operative to: receive from a server a request for NIDD downlink data transfer to a terminal device; trigger, when no PDN connection is available between the terminal device and the network node, establishment by the terminal device of a PDN connection with the network node; and notify the server when the PDN connection has been established.

In an embodiment, the memory 630 may further contain instructions executable by the processor 620 whereby the network node 600 is operative to: receive from the server an NIDD configuration request containing a PDN connection establishment option requesting the network node to trigger establishment by the terminal device of a PDN connection with the network node when no PDN connection is available between the terminal device and the network node.

In an embodiment, the PDN connection establishment option may further request the network node to buffer data from the server when no PDN connection is available between the terminal device and the network node. The memory 630 may further contain instructions executable by the processor 620 whereby the network node 600 is operative to: buffer data contained in the request for NIDD downlink data transfer when no PDN connection is available between the terminal device and the network node; and transmit, subsequent to triggering establishment of the PDN connection, to the server a response indicating that the establishment of the PDN connection has been triggered and the data has been buffered.

In an embodiment, the PDN connection establishment option may not request the network node to buffer data from the server when no PDN connection is available between the terminal device and the network node. The memory 630 may further contain instructions executable by the processor 620 whereby the network node 600 is operative to: transmit to the server a response indicating delivery failure when no PDN connection is available between the terminal device and the network node.

In an embodiment, the NIDD configuration request may further contain an indication requesting the network node to notify the server when the PDN connection has been established.

In an embodiment, the request for NIDD downlink data transfer may further contain an indication requesting the network node to notify the server when the PDN connection has been established.

In an embodiment, the memory 630 may further contain instructions executable by the processor 620 whereby the network node 600 is operative to: negotiate with the server one or more supported features for an NIDD API between the network node and the server, the one or more supported features including a feature to notify the server when the PDN connection has been established.

In an embodiment, the network node may be an SCEF node or an NEF node, the server may be an SCS/AS, the request for NIDD downlink data transfer may be an MT NIDD Submit Request, the operation of triggering establishment of the PDN connection may include transmitting a Device Trigger destined to the terminal device, and/or the operation of notifying the server when the PDN connection has been established may include transmitting to the server an NIDD Configuration Update Notification containing an indication that the PDN connection has been established.

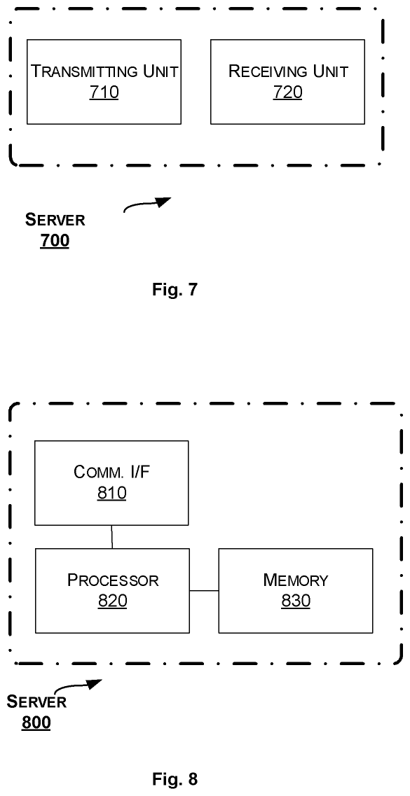

Correspondingly to the method 200 as described above, a server is provided. FIG. 7 is a block diagram of a server 700 according to an embodiment of the present disclosure.

As shown in FIG. 7, the server 700 includes a transmitting unit 710 configured to transmit to a network node a request for NIDD downlink data transfer to a terminal device. The server 700 further includes a receiving unit 720 configured to receive from the network node a response without an indication of delivery success; and receive from the network node a notification that a PDN connection has been established between the terminal device and the network node.

In an embodiment, the transmitting unit 710 can be further configured to transmit to the network node an NIDD configuration request containing a PDN connection establishment option requesting the network node to trigger establishment by the terminal device of a PDN connection with the network node when no PDN connection is available between the terminal device and the network node.

In an embodiment, the PDN connection establishment option may further request the network node to buffer data from the server when no PDN connection is available between the terminal device and the network node, and the response may indicate that the establishment of the PDN connection has been triggered and the data has been buffered.

In an embodiment, the PDN connection establishment option may not request the network node to buffer data from the server when no PDN connection is available between the terminal device and the network node, and the response may indicate delivery failure.

In an embodiment, the NIDD configuration request may further contain an indication requesting the network node to notify the server when the PDN connection has been established.

In an embodiment, the request for NIDD downlink data transfer may contain an indication requesting the network node to notify the server when the PDN connection has been established.

In an embodiment, the server 700 may further include a negotiating unit configured to negotiate with the network node one or more supported features for an NIDD API between the network node and the server, the one or more supported features including a feature to notify the server when the PDN connection has been established.

In an embodiment, the transmitting unit 710 can be further configured to transmit to the network node a further request for NIDD downlink data transfer to the terminal device in response to the notification.

In an embodiment, the server may be an SCS/AS, the network node may be an SCEF node or an NEF node, the request for NIDD downlink data transfer may be an MT NIDD Submit Request, and/or the notification may be an NIDD Configuration Update Notification.

The transmitting unit 710 and the receiving unit 720 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 2.

FIG. 8 is a block diagram of a server 800 according to another embodiment of the present disclosure.

The server 800 includes a communication interface 810, a processor 820 and a memory 830. The memory 830 contains instructions executable by the processor 820 whereby the server 800 is operative to perform the actions, e.g., of the procedure described earlier in conjunction with FIG. 2. Particularly, the memory 830 contains instructions executable by the processor 820 whereby the server 800 is operative to: transmit to a network node a request for NIDD downlink data transfer to a terminal device; receive from the network node a response without an indication of delivery success; and receive from the network node a notification that a PDN connection has been established between the terminal device and the network node.

In an embodiment, the memory 830 may further contain instructions executable by the processor 820 whereby the server 800 is operative to: transmit to the network node an NIDD configuration request containing a PDN connection establishment option requesting the network node to trigger establishment by the terminal device of a PDN connection with the network node when no PDN connection is available between the terminal device and the network node.

In an embodiment, the PDN connection establishment option may further request the network node to buffer data from the server when no PDN connection is available between the terminal device and the network node, and the response may indicate that the establishment of the PDN connection has been triggered and the data has been buffered.

In an embodiment, the PDN connection establishment option may not request the network node to buffer data from the server when no PDN connection is available between the terminal device and the network node, and the response may indicate delivery failure.

In an embodiment, the NIDD configuration request may further contain an indication requesting the network node to notify the server when the PDN connection has been established.

In an embodiment, the request for NIDD downlink data transfer may contain an indication requesting the network node to notify the server when the PDN connection has been established.

In an embodiment, the memory 830 may further contain instructions executable by the processor 820 whereby the server 800 is operative to: negotiate with the network node one or more supported features for an NIDD API between the network node and the server, the one or more supported features including a feature to notify the server when the PDN connection has been established.

In an embodiment, the memory 830 may further contain instructions executable by the processor 820 whereby the server 800 is operative to: transmit to the network node a further request for NIDD downlink data transfer to the terminal device in response to the notification.

In an embodiment, the server may be an SCS/AS, the network node may be an SCEF node or an NEF node, the request for NIDD downlink data transfer may be an MT NIDD Submit Request, and/or the notification may be an NIDD Configuration Update Notification.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 620 causes the network node 600 to perform the actions, e.g., of the procedure described earlier in conjunction with FIG. 1; or code/computer readable instructions, which when executed by the processor 820 causes the server 800 to perform the actions, e.g., of the procedure described earlier in conjunction with FIG. 2.

The computer program product may be configured as a computer program code structured in computer program modules. The computer program modules could essentially perform the actions of the flow illustrated in FIG. 1 or 2.

The processor may be a single CPU (Central Processing Unit), but could also comprise two or more processing units. For example, the processor may include general purpose microprocessors; instruction set processors and/or related chips sets and/or special purpose microprocessors such as Application Specific Integrated Circuits (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random-Access Memory (RAM), a Read-Only Memory (ROM), or an EEPROM, and the computer program modules described above could in alternative embodiments be distributed on different computer program products in the form of memories.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

1. A method in a network node for facilitating Non-Internet Protocol Data Delivery, NIDD, comprising:
receiving from a server a request for NIDD downlink data transfer to a terminal device;
triggering, when no Packet Data Network, PDN, connection is available between the terminal device and the network node, establishment by the terminal device of a PDN connection with the network node; and
notifying the server when the PDN connection has been established.

2. The method of claim 1, further comprising:
receiving from the server an NIDD configuration request containing a PDN connection establishment option requesting the network node to trigger establishment by the terminal device of a PDN connection with the network node when no PDN connection is available between the terminal device and the network node.

3. The method of claim 2, wherein the PDN connection establishment option further requests the network node to buffer data from the server when no PDN connection is available between the terminal device and the network node, and the method further comprises:
buffering data contained in the request for NIDD downlink data transfer, when no PDN connection is available between the terminal device and the network node; and
transmitting, subsequent to triggering establishment of the PDN connection, to the server a response indicating that the establishment of the PDN connection has been triggered and the data has been buffered.

4. The method of claim 2, wherein the PDN connection establishment option does not request the network node to buffer data from the server when no PDN connection is available between the terminal device and the network node, and the method further comprises:
transmitting to the server a response indicating delivery failure when no PDN connection is available between the terminal device and the network node.

5. The method of claim 2, wherein the NIDD configuration request further contains an indication requesting the network node to notify the server when the PDN connection has been established.

6. The method of claim 1, wherein the request for NIDD downlink data transfer contains an indication requesting the network node to notify the server when the PDN connection has been established.

7. The method of claim 5, further comprising:
negotiating with the server one or more supported features for an NIDD Application Programming Interface, API, between the network node and the server, the one or more supported features comprising a feature to notify the server when the PDN connection has been established.

8. The method of claim 1, wherein
the network node is a Service Capability Exposure Function, SCEF, node or a Network Exposure Function, NEF, node,
the server is a Service Capability Server, SCS, /Application Server, AS, the request for NIDD downlink data transfer is a Mobile Terminated, MT, NIDD Submit Request, said triggering establishment of the PDN connection comprises transmitting a Device Trigger destined to the terminal device, and/or
said notifying the server when the PDN connection has been established comprises transmitting to the server an NIDD Configuration Update Notification containing an indication that the PDN connection has been established.

9. A network node, comprising a communication interface, a processor and a memory, the memory comprising instructions executable by the processor whereby the network node is operative to perform the method according to claim 1.

10. (canceled)

11. A method in a server for facilitating Non-Internet Protocol Data Delivery, NIDD, comprising:
transmitting to a network node a request for NIDD downlink data transfer to a terminal device;
receiving from the network node a response without an indication of delivery success; and
receiving from the network node a notification that a Packet Data Network, PDN, connection has been established between the terminal device and the network node.

12. The method of claim 11, further comprising:
transmitting to the network node an NIDD configuration request containing a PDN connection establishment option requesting the network node to trigger establishment by the terminal device of a PDN connection with the network node when no PDN connection is available between the terminal device and the network node.

13. The method of claim 12, wherein the PDN connection establishment option further requests the network node to buffer data from the server when no PDN connection is available between the terminal device and the network node, and the response indicates that the establishment of the PDN connection has been triggered and the data has been buffered.

14. The method of claim 12, wherein the PDN connection establishment option does not request the network node to buffer data from the server when no PDN connection is available between the terminal device and the network node, and the response indicates delivery failure.

15. The method of claim 12, wherein the NIDD configuration request further contains an indication requesting the network node to notify the server when the PDN connection has been established.

16. The method of claim 11, wherein the request for NIDD downlink data transfer contains an indication requesting the network node to notify the server when the PDN connection has been established.

17. The method of claim 15, further comprising:
negotiating with the network node one or more supported features for an NIDD Application Programming Interface, API, between the network node and the server, the one or more supported features comprising a feature to notify the server when the PDN connection has been established.

18. The method of claim 11, further comprising:
transmitting to the network node a further request for NIDD downlink data transfer to the terminal device in response to the notification.

19. The method of claim 11, wherein the server is a Service Capability Server, SCS, /Application Server, AS, the network node is a Service Capability Exposure Function, SCEF, node or a Network Exposure Function, NEF, node, the request for NIDD downlink data transfer is a Mobile Terminated, MT, NIDD Submit Request, and/or the notification is an NIDD Configuration Update Notification.

20-21. (canceled)
